(19) United States
(12) Patent Application Publication
(10) Pub. No.: US 2012/0287283 A1
(43) Pub. Date: Nov. 15, 2012

(54) ELECTRONIC DEVICE WITH VOICE PROMPT FUNCTION AND VOICE PROMPT METHOD

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/323,961

(22) Filed: Dec. 13, 2011

(30) Foreign Application Priority Data
May 9, 2011 (CN) 201110117922.7

(51) Int. Cl. H04N 7/18

(52) U.S. Cl. 348/158; 348/143; 348/E07.085

(57) ABSTRACT

An electronic device includes an image capturing unit and a processor. The processor controls the image capturing unit to periodically capture the environment surrounding the electronic device to obtain an image, and further compares the captured image with at least one pre-stored image corresponding to a destination point to determine whether a difference between the captured image and one of the pre-stored image is less than a preset value. The processor outputs an audio prompt to prompt the user that he/she is arriving at the destination point if a difference between the captured image and one pre-stored image is less than a preset value. A voice prompt method applied in an electronic device is also provided.

### BACKGROUND

1. Technical Field

The present disclosure relates to electronic devices and, particularly, to an electronic device having a voice prompt function and a voice prompt method.

2. Description of Related Art

When a passenger on a bus is listening to music or watching a movie on a portable device, such as, a mobile phone, for example, an announcement of the arrival at the destination may go unheard, and the destination stop may be missed. Therefore, there is room for improvement in the art.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like pre-stored numerals designate corresponding parts throughout several views.

FIG. 1 is a block diagram of a portable electronic device with a voice prompt function, in accordance with an embodiment.

FIG. 2 is a schematic view showing a pre-stored image.

FIG. 3 is a schematic view showing an image captured by the portable electronic device of FIG. 1.

FIG. 4 is a flowchart of a voice prompt method, in accordance with an embodiment.

### DETAILED DESCRIPTION

Embodiments of the present disclosure will now be described in detail with reference to the drawings.

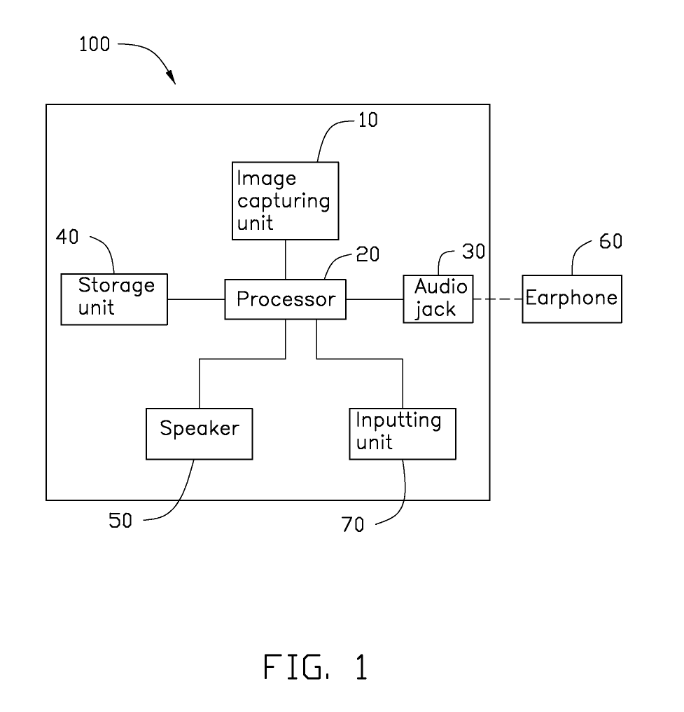

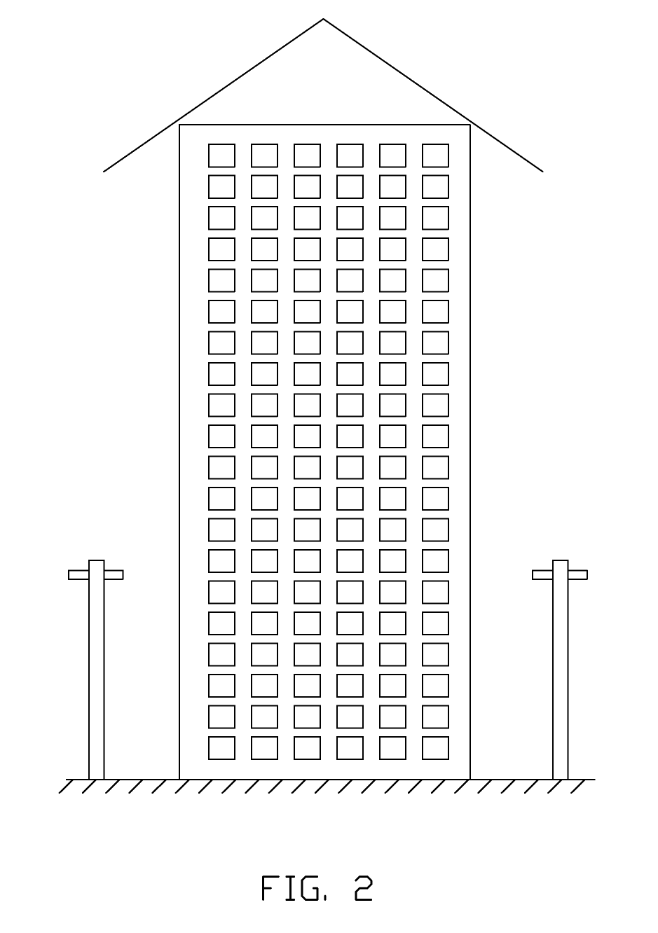

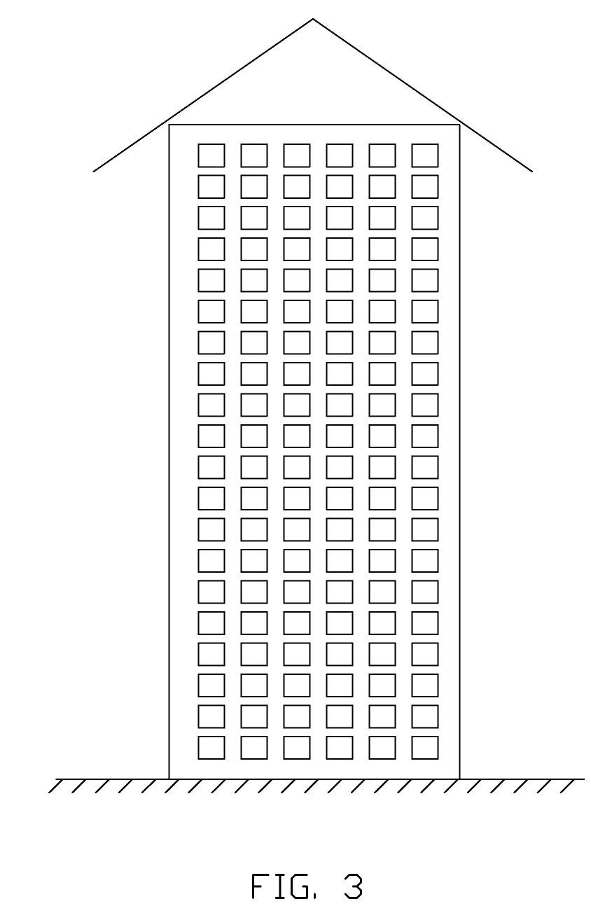

Referring to FIG. 1, an embodiment of an electronic device 100 with a voice prompt function is illustrated. In this embodiment, when a user is using public transportation such as a bus, the electronic device 100 periodically captures an environment surrounding the electronic device 100 in real time to obtain an image (see FIG. 3), and compares the captured image with at least one pre-stored image (see FIG. 2). If a difference between the captured image and a pre-stored image is less than a preset value, the electronic device 100 determines a destination point corresponding to the pre-stored image, and outputs a voice prompt to prompt that the bus is arriving at the destination point. The electronic device 100 may be a mobile phone, or a portable media player.

The electronic device 100 includes an image capturing unit 10, a processor 20, an audio jack 30, a storage unit 40, and a speaker 50. The audio jack 30 can be connected with audio output devices such as an earphone 60. The storage unit 40 stores an address table recording at least one destination point, at least one pre-stored image corresponding to each destination point, and a number of pixels of each pre-stored image. The image capturing unit 10 periodically captures the environment surrounding the electronic device 100 to obtain an image. In this embodiment, the image capturing unit 10 is arranged on an earphone (not shown) which can be electrically connected to the audio jack 30, thus the image capturing unit 10 can capture the environment outside the public transportation such as a bus when the user is listening to music or watching a movie while on the bus. In an alternative embodiment, the image capturing unit 10 may be hung about the neck of the user when in use and can communicate with the electronic device 100 wirelessly.

The processor 20 compares the captured image with each pre-stored image to determine whether a difference between the captured image and one pre-stored image is less than a preset value. If yes, the processor 20 determines a destination point corresponding to the pre-stored image according to the address table, and executes an audio prompt function to prompt the user that he/she is arriving at the destination point. In this embodiment, the processor 20 obtains the number of the pixels of the captured image using known technology, and compares the obtained number with the number of pixels of each pre-stored image. If a difference between the number of pixels of the captured image and one pre-stored image is less than the preset value, the processor 20 executes the audio prompt function.

In this embodiment, the processor 20 executes the audio prompt function as follows. The processor 20 determines whether the electronic device 100 is executing multimedia operation, such as playing an audio file, playing a video file, and receiving broadcast, and determines whether an earphone is connected to the audio jack 30. If the electronic device 100 is executing a multimedia operation, the processor 20 pauses the operation. In addition, the processor 20 outputs an audio prompt through the audio jack 50, when an earphone is electrically connected to the audio jack 50 (or directly outputs the audio prompts through the speaker 50) to prompt that the bus is arriving at the destination point corresponding to the pre-stored image. If the electronic device 100 is not executing the multimedia operation, the processor 20 directly outputs the audio prompt through the audio jack 50 while an earphone is electrically connected to the audio jack 50 (or directly outputs the audio prompts through the speaker 50). In this embodiment, after finishing output of the audio prompt, the processor 20 resumes execution of the multimedia operation.

The electronic device 100 further includes an inputting unit 70 for generating input signals in response to an input operation of the user. The processor 20 further receives the input signals to update or edit the address table.

The electronic device 100 may further include a special key (not shown) for starting the audio prompt function of the electronic device 100. The electronic device 100 can also provide a menu having a starting audio prompt function option for the user to select whether to start the audio prompt function.

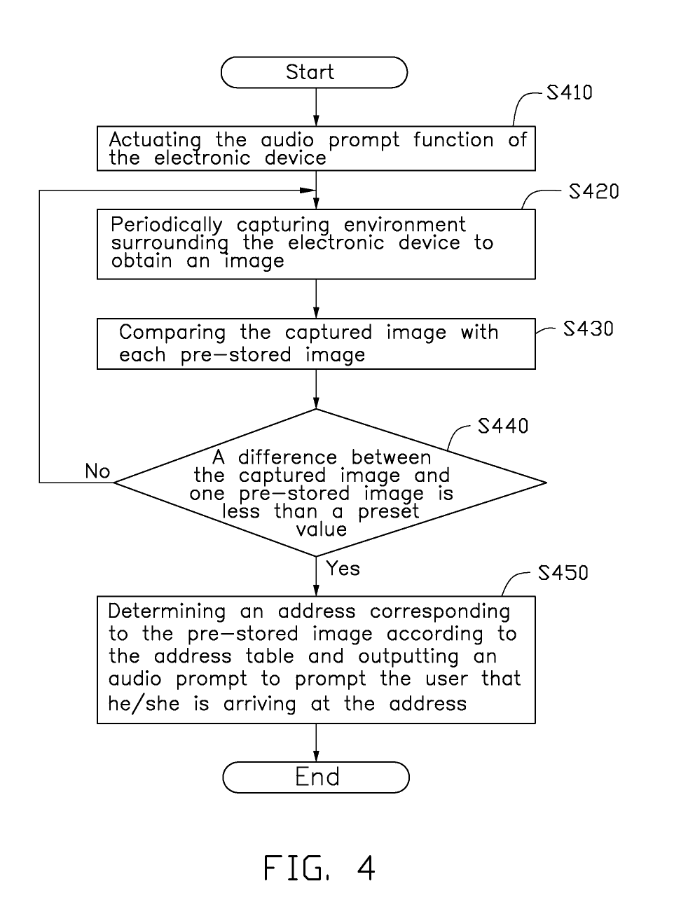

FIG. 4 is a flowchart of a voice prompt method applied in the electronic device 100, in accordance with an embodiment.

In step S410, the processor 150 actuates the audio prompt function of the electronic device 100 if the special key is pressed or starts the audio prompt function option when a menu item is selected.

In step S420, the image capturing unit 10 periodically captures the environment surrounding the electronic device 100 to obtain an image.

In step S430, the processor 20 compares the captured image with each pre-stored image.

In step S440, the processor 20 determines whether a difference between the captured image and a pre-stored image is less than a preset value. If the difference between the captured image and one pre-stored image is less than a preset value, the procedure goes to step S450, and if not, the procedure returns to S420.

In step S450, the processor 20 determines a destination point corresponding to the pre-stored image according to the address table, and outputs an audio prompt to prompt the user that he/she is arriving at the destination point.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
an image capturing unit; and
a processor for controlling the image capturing unit to periodically capture environment surrounding the electronic device to obtain an image, and comparing the captured image with at least one pre-stored image corresponding to a destination point to determine whether a difference between the captured image and one of the pre-stored image is less than a preset value, and further outputting an audio prompt if a difference between the captured image and one pre-stored image is less than the preset value.

2. The electronic device as described in claim 1, wherein the processor obtains the number of the pixels of the captured image, and compares the obtained number with the number of pixels of each pre-stored image to determine whether the difference between the captured image and the one pre-stored image is less than the preset value.

3. The electronic device as described in claim 2, wherein the electronic device further comprises a storage unit, the storage unit stores an address table recording the at least one pre-stored image, and at least one destination point corresponding to each pre-stored image.

4. The electronic device as described in claim 3, wherein the storage unit further records the number of pixels of each pre-stored image.

5. The electronic device as described in claim 1, further comprising an earphone for playing the audio prompt.

6. The electronic device as described in claim 5, wherein the image capturing unit is arranged at the earphone.

7. A voice prompt method applied in an electronic device, the electronic device comprising an image capturing unit, the method comprising:
controlling the image capturing unit to periodically capture environment surrounding the electronic device to obtain an image;
comparing the captured image with at least one pre-stored image corresponding to a destination point to determine whether a difference between the captured image and one pre-stored image is less than a preset value; and
outputting an audio prompt if a difference between the captured image and one of the pre-stored image is less than a preset value.

8. The voice prompt method as described in claim 7, further comprising:
providing an address table recording the at least one pre-stored image, at least one destination point corresponding to each pre-stored image, and a number of pixels of the pre-stored image.

9. The voice prompt method as described in claim 8, wherein the step of comparing the captured image with at least one pre-stored image corresponding to a destination point to determine whether a difference between the captured image and one pre-stored image is less than a preset value comprises:
obtaining a number of pixels of the captured image;
comparing the obtain number of pixels of the captured image with the number pixels of each pre-stored image; and
determining that a difference between the captured image and one pre-stored image is less than a preset value if a difference between the obtain number of pixels of the captured image and the number pixels of each pre-stored image is less than a preset value.

10. The voice prompt method as described in claim 9, wherein the electronic device comprises a storage unit for storing the address table.
